(19) United States
(12) Patent Application Publication
(10) Pub. No.: US 2026/0203375 A1
(43) Pub. Date: Jul. 16, 2026

(54) ANALYSIS SYSTEM AND ANALYSIS METHOD

(71) Applicant: TOYOTA JIDOSHA KABUSHIKI KAISHA, Toyota-shi (JP)

(72) Inventor: Kazuho SAEKI, Kawasaki-shi (JP)

(73) Assignee: TOYOTA JIDOSHA KABUSHIKI KAISHA, Toyota-shi (JP)

(21) Appl. No.: 19/411,831

(22) Filed: Dec. 8, 2025

(30) Foreign Application Priority Data
Jan. 16, 2025 (JP) 2025-006091

(51) Int. Cl. G06F 18/22; G06F 18/2135

(52) U.S. Cl. CPC G06F 18/22; G06F 18/2135

(57) ABSTRACT

An analysis system according to the present disclosure includes an actual measurement score acquisition unit, a simulated score acquisition unit, a resemblance evaluation unit, and a presentation unit. The actual measurement score acquisition unit acquires the feature amount of the measurement data obtained by actually measuring the sample as the actual measurement score. The simulated score acquisition unit acquires the feature amount of the simulated sample defined by the user as the simulated score. The resemblance evaluation unit evaluates the resemblance between the plurality of measured scores and the simulated score. The presentation unit presents a sample having an actual measurement score with the highest resemblance to the simulated score.

### CROSS-REFERENCE TO RELATED APPLICATION

This application claims priority to Japanese Patent Application No. 2025-006091 filed on Jan. 16, 2025. The disclosure of the above-identified application, including the specification, drawings, and claims, is incorporated by reference herein in its entirety.

### BACKGROUND

### 1. Technical Field

The present disclosure relates to an analysis system and an analysis method.

### 2. Description of Related Art

Japanese Unexamined Patent Application Publication No. 2024-073299 (JP 2024-073299 A) describes an information processing apparatus that executes operation to generate two-dimensional map data in which each of a plurality of spectral data is projected into two dimensions as each of a plurality of plot points by applying principal component analysis, specify unknown data representing a plot point different from a plot point already existing in the two-dimensional map data, and convert the unknown data into spectral data.

### SUMMARY

When a user specifies unknown data as in the technique described in JP 2024-073299 A, there is a possibility that it is necessary to confirm spectral data of a sample similar to the specified unknown data. In other words, when the user specifies a simulated sample, it may be necessary to confirm measurement data of a sample similar to the simulated sample.

However, it is difficult to find a sample similar to the simulated sample from among a plurality of samples, and the user may feel annoyed during confirmation. JP 2024-073299 A does not disclose a technique capable of addressing such an issue.

The present disclosure has been made in view of addressing such an issue, and has an object to provide an analysis system and an analysis method that allow a user to easily confirm a sample similar to a simulated sample.

An aspect of the present disclosure provides an analysis system including:
an actual measurement score acquisition unit that acquires a characteristic amount of measurement data obtained by actually measuring a sample as an actual measurement score;
a simulated score acquisition unit that acquires a characteristic amount of a simulated sample specified by a user as a simulated score;
a resemblance evaluation unit that evaluates resemblance between a plurality of actual measurement scores and the simulated score; and
a presentation unit that presents the sample having the actual measurement score with a highest resemblance to the simulated score.

The analysis system according to the aspect of the present disclosure may further include
a simulated data output unit that simulates measurement data of the simulated sample based on the simulated score and outputs the simulated measurement data as simulated data; and the presentation unit may display the measurement data of the sample having the actual measurement score with the highest resemblance to the simulated score and the simulated data in parallel.

In the analysis system according to the aspect of the present disclosure, the characteristic amount may be a principal component score obtained as a result of performing a principal component analysis on a plurality of pieces of the measurement data.

In the analysis system according to the aspect of the present disclosure,
the resemblance evaluation unit may determine whether the simulated score corresponds to an outlier value in a data group including a plurality of actual measurement scores acquired; and
the presentation unit may not present the sample when the resemblance evaluation unit determines that the simulated score corresponds to an outlier value.

An aspect of the present disclosure provides an analysis method including:
acquiring a characteristic amount of measurement data obtained by actually measuring a sample as an actual measurement score;
acquiring a characteristic amount of a simulated sample specified by a user as a simulated score;
evaluating resemblance between a plurality of actual measurement scores and the simulated score; and
presenting the sample having the actual measurement score with a highest resemblance to the simulated score.

According to the present disclosure, it is possible to provide an analysis system and an analysis method that allow a user to easily confirm a sample similar to a simulated sample.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of an analysis system according to a first embodiment;

FIG. 2 is a block diagram illustrating a configuration of a server according to the first embodiment;

FIG. 3 is a block diagram illustrating a configuration of a server according to the first embodiment;

FIG. 4 is a schematic screen diagram for explaining the configuration of the server according to the first embodiment;

FIG. 5 is a schematic diagram for describing the configuration of the servers according to the first embodiment; and

FIG. 6 is a flowchart illustrating an operation of the analysis system according to the first embodiment.

### DETAILED DESCRIPTION OF EMBODIMENTS

### First Embodiment

### Configuration of Display Control System

Hereinafter, a first embodiment according to the present disclosure will be described in detail with reference to the drawings. First, the configuration of the display control system according to the present embodiment will be described in detail.

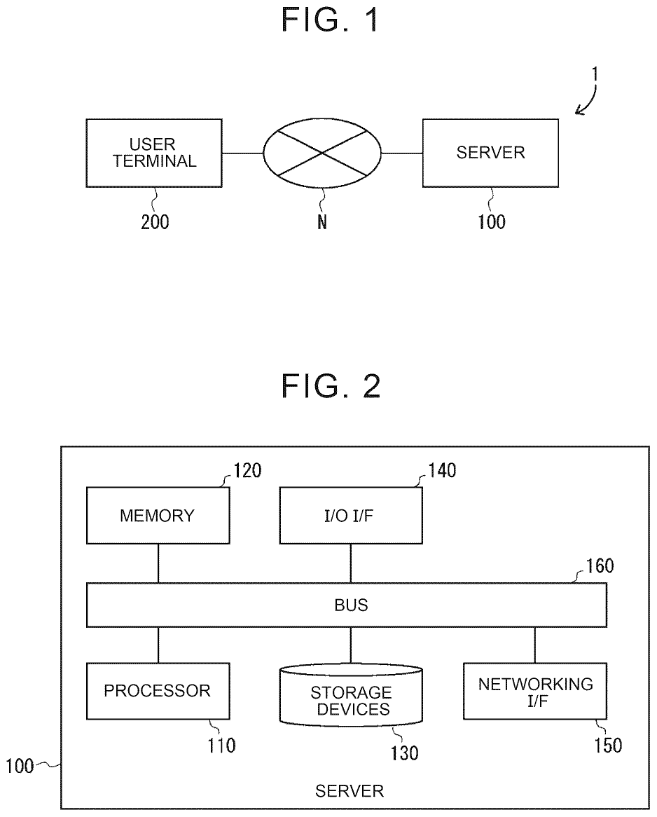

FIG. 1 is a block diagram illustrating a configuration of an analysis system according to a first embodiment. As illustrated in FIG. 1, the analysis system 1 according to the present embodiment is connected to a server 100 and a user terminal 200 via a network N such as the Internet.

The analysis system 1 is a system for analyzing measurement data obtained by actually measuring a sample.

The analysis system 1 according to the present embodiment is typically provided as a part of a data cloud type service used in material development and research and development, and is used as a so-called material informatics (MI, Materials Informatics) or a system for promoting research and development using data science.

In the analysis system 1, the user terminal 200 transmits measurement data to the server 100, and the server 100 analyzes the received measurement data.

Then, the server 100 transmits the analysis result to the user terminal 200, and the user terminal 200 displays the received analysis result.

Examples of the measurement data analyzed by the analysis system 1 include spectral data, waveform data, graph data, secondary image data, and three-dimensional image data.

Examples of the spectral data include spectral data measured using nuclear magnetic resonance spectroscopy (NMR, Nuclear Magnetic Resonance spectroscopy), infrared spectroscopy (IR, InfraRed spectroscopy), ultraviolet-visible spectroscopy (UV-vis, Ultra Violet-Visible spectroscopy), X-ray absorptiometry (XAS, X-ray Absorption Spectroscopy), Raman spectroscopy, X-ray diffractometry (XRD, X-ray diffraction), X-ray small-angle scattering (SAXS, Small Angle X-ray Scattering), and mass-spectroscopy (MS, Mass Spectrometry).

Examples of the two-dimensional image data include image data captured using an optical microscope, a scanning electron microscope (SEM, Scanning Electron Microscope), a transmission electron microscope (TEM, Transmission Electron Microscope), and computed tomography (CT, Computed tomography).

Examples of the three-dimensional image data include image data generated by stacking tomograms captured by computed tomography (CT), model data generated by CAD (Computer-Aided design), and the like.

Examples of the wave system data include time series data and displacement data. Examples of the time-series data include acoustic data, vibration data, and the like, but any data whose numerical value changes with time can be taken as a target. The displacement data includes, for example, a surface height of a sample, a surface profile, and the like, and any data whose numerical value changes with changes in coordinates and other parameters can be taken as an object.

Further, examples of other data include cyclic voltammograms and gas chromatography (GC, Gas Chromatography) charts.

Further, as the measured data, for example, coordinate data such as a CIF (Crystallographic Information) file or numerical data such as a composition-component table can be used.

The user terminal 200 according to the present embodiment is a terminal operated by a user, and is typically a computer device having a display device.

The user terminal 200 transmits the measurement data to the server 100 via the network N. Then, the user terminal 200 receives the analysis result of the measurement data from the server 100 via the network N.

The server 100 according to the present embodiment receives the measurement data from the user terminal 200 and analyzes the received measurement data. Then, the server 100 transmits the analysis result to the user terminal 200 via the network N.

FIG. 2 is a block diagram illustrating a hard configuration of the server according to the first embodiment.

As illustrated in FIG. 2, the server 100 includes a processor 110, a memory 120, a storage device 130, an input/output interface 140, a network interface 150, and an internal bus 160.

The internal bus 160 is a data transmission path through which the processor 110, the memory 120, the storage device 130, the input/output interface 140, and the network interface 150 transmit and receive data to and from each other. However, the method of connecting the processors 110 and the like to each other is not limited to the bus connection. 30

The memory 120 is a main storage device realized by using RAM (Random Access Memory).

The storage device 130 is an auxiliary storage device realized by using a hard disk, an SSD (Solid State Drive), a memory card, a ROM (Read Only Memory), or the like. The storage device 130 stores a program for realizing a desired function.

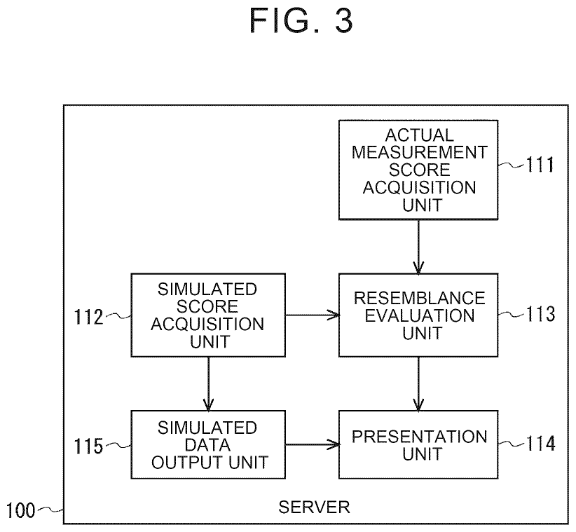

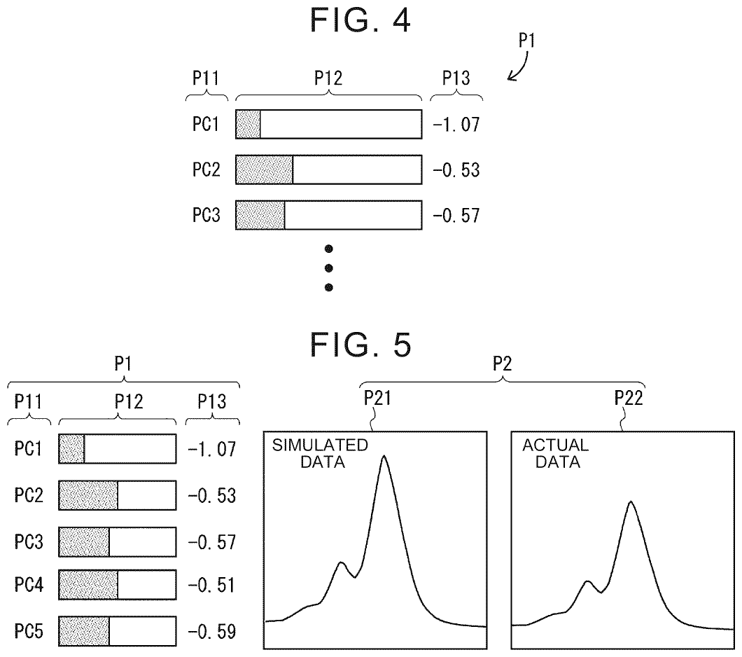

The processor 110 is a variety of processors, such as CPU (Central Processing Unit), GPU (Graphics Processing Unit), or FPGA (field-programmable gate array). The processor 110 reads a program stored in the storage device 130 into the memory 120 and executes the program, thereby executing functions as functional blocks illustrated in FIG. 3 and FIG. 4, which will be described later.

The input/output interface 140 is an interface for connecting the server 100 and the input/output device. For example, an input device such as a keyboard or an output device such as a display device may be connected to the input/output interface 140. The network interface 150 is an interface for connecting the server 100 to a network.

It should be noted that the program includes instructions (or software code) for causing a computer to perform one or more of the functions described in the embodiments when loaded into the computer. The program may be stored in a non-transitory computer-readable medium or a tangible storage medium. By way of example, and not limitation, computer-readable media or tangible storage media include RAM, ROM, flash memory, SSD or other memory techniques, CD-ROM, DVD (digital versatile disc), Blu-ray disk (registered trademark) or other optical disk storage, magnetic cassettes, magnetic tape, magnetic disk storage, or other magnetic storage devices. The program may be transmitted on a transitory computer readable medium or a communication medium. By way of example, and not limitation, transitory computer-readable media or communication media include electrical, optical, acoustic, or other forms of propagated signals.

FIG. 3 is a block diagram illustrating functions of the server 100 according to the first embodiment.

As illustrated in FIG. 3, the server 100 according to the present embodiment includes an actual measurement score acquisition unit 111, a simulated score acquisition unit 112, a resemblance evaluation unit 113, a presentation unit 114, and a simulated data output unit 115 as functional blocks.

The actual measurement score acquisition unit 111 acquires the feature amount of the measurement data obtained by actually measuring the sample as the actual measurement score. The actual measurement score acquisition unit 111 outputs the acquired actual measurement score to the resemblance evaluation unit 113.

For example, the actual measurement score acquisition unit 111 according to the present embodiment may acquire the actual measurement score by performing principal component analysis (PCA, Principle Component Analysis) on the plurality of measurement data. That is, in the present embodiment, the feature amount may be a principal component score obtained as a result of principal component analysis of a plurality of pieces of measurement data.

Therefore, the actual measurement score acquisition unit 111 according to the present embodiment outputs a plurality of principal component scores to the resemblance evaluation unit 113. In addition, the actual measurement score acquisition unit 111 according to the present embodiment outputs the principal component obtained as a result of the principal component analysis to the simulated data output unit 115.

However, the configuration of the actual measurement score acquisition unit 111 according to the present disclosure is not limited to the above. For example, the actual measurement score acquisition unit 111 does not need to extract the feature amount from the measurement data. In this case, the actual measurement score acquisition unit 111 may acquire the feature amount recorded in association with the measurement data in advance. That is, the actual measurement score acquisition unit 111 may acquire the actual measurement score from the database in which the measurement data and the feature amount are recorded in association with each other.

The actual measurement score acquired by the actual measurement score acquisition unit 111 is not limited to the principal component. The actual measurement score may be obtained as an actual measurement score as long as it is a feature quantity extracted by a known analysis method.

The simulated score acquisition unit 112 acquires the feature amount of the simulated sample defined by the user as the simulated score. The simulated score acquisition unit 112 outputs the acquired simulated score to the resemblance evaluation unit 113 and the simulated data output unit 115.

Here, the simulated sample refers to a virtual sample defined by a user setting a feature amount. The simulated sample does not need to be strictly defined up to the details, and at least the feature quantity used as the simulated score may be defined. Further, the simulated sample may be defined by the simulated score acquisition unit 112 acquiring the simulated score.

The simulated score acquisition unit 112 acquires the same type of feature amount as the actual measurement score as the simulated score. Therefore, in the present embodiment, the principal component score defined by the user is acquired as a simulated score.

The simulated score acquisition unit 112 according to the present embodiment acquires the simulated score by receiving the feature amount of the simulated sample from the user. More specifically, the simulated score acquisition unit 112 according to the present embodiment controls the user terminal 200 to cause the user terminal 200 to display a control screen for accepting the simulated score.

FIG. 4 is a schematic screen diagram for describing the configuration of the simulated score acquisition unit 112 according to the first embodiment. More specifically, FIG. 4 is an example of a control screen displayed on the user terminal 200 by the simulated score acquisition unit 112 in order to receive the dummy score.

As illustrated in FIG. 4, the simulated score acquisition unit 112 may display, on the user terminal 200, a control screen P1 in which the identification image P11 of the feature amount, the bar P12 indicating the size of the feature amount, and the value P13 of the feature amount are displayed side by side.

The identification image P11 of the feature amount is an image given by the user to identify the feature amount, and is typically an image in which the name of the feature amount is displayed as text.

For example, as illustrated in FIG. 4, the identification image P11 according to the present embodiment is a textual image described as “PC1”, “PC2”, and “PC3”, and these are names representing the first principal component, the second principal component, and the third principal component, respectively.

The bar P12 visually represents the size of the feature quantity corresponding to the neighboring identification image P11. Here, the bar P2 is configured such that the size of the feature quantity can be changed by a user's dragging operation.

The value P13 of the feature amount indicates the value of the feature amount corresponding to the neighboring identification images P11 and the bar P12. Here, when the size of the feature amount is changed by dragging to the bar P12, the value P13 displays the size of the changed feature amount.

The value P13 may be configured to allow a user to enter a specific numerical value. In this case, the simulated score acquisition unit 112 changes the display of the bar P12 in accordance with the specific numerical value inputted to the value P13.

The simulated score acquisition unit 112 according to the present embodiment causes the user terminal 200 to display a control screen as illustrated in FIG. 4, and causes the user to operate the control screen, thereby receiving a simulated score from the user.

More specifically, the simulated score acquisition unit 112 causes the user to operate at least one of the bar P12 and the value P13. The simulated score acquisition unit 112 accepts, as a simulated score, the value of the characteristic quantity changed by operating at least one of the bar P12 and the value P13.

The simulated data output unit 115 acquires a simulated score from the simulated score acquisition unit 112. The simulated data output unit 115 simulates the measurement data of the simulated sample based on the simulated score, and outputs the simulated data.

For example, the simulated data output unit 115 according to the present embodiment may acquire the principal component from the actual measurement score acquisition unit 111 and acquire the principal component score defined by the user from the simulated score acquisition unit 112 as the simulated score. The simulated data may be output based on the acquired principal component and the simulated score.

In the above-described cases, the simulated data output unit 115 may output the simulated data by, for example, calculating a vector D^{rec} indicating the simulated data according to Equation (1) below.

$${D}^{rec} = {S}_{1}^{′} {v}_{1} + {S}_{2}^{′} {v}_{2} + … + {S}_{10}^{′} {v}_{10} \qquad Equation ( 1 )$$

However,
S′ₖ is the principal component score of the k-th principal component defined by the user,
nₖ is the vector-displayed principal component.

The resemblance evaluation unit 113 acquires a plurality of measured scores from the actual measurement score acquisition unit 111, and acquires a simulated score from the simulated score acquisition unit 112. The resemblance evaluation unit 113 evaluates the resemblance between a plurality of measured scores and a simulated score. The resemblance evaluation unit 113 outputs the evaluation result of the resemblance between the actual measurement scores and the simulated scores to the presentation unit 114.

The method used by the resemblance evaluation unit 113 to evaluate the resemblance is not particularly limited. For example, the evaluation method may be an evaluation method using a distance function (Distance Function) or an evaluation method using a resemblance function (Similarity function). The resemblance evaluation unit 113 may evaluate the resemblance using artificial intelligence, for example.

The method of evaluating the degree of resemblance may be appropriately selected according to, for example, the feature amount to be evaluated, or may be appropriately selected by the user.

That is, the resemblance evaluation unit 113 may perform evaluation of the resemblance using any method as long as it can appropriately evaluate the resemblance between the actual measurement score and the simulated score.

Further, the resemblance evaluation unit 113 according to the present embodiment determines whether or not the simulated score corresponds to the outlier value in the data group including the plurality of acquired actual measurement scores. When determining that the simulated score is an outlier, the resemblance evaluation unit 113 notifies the presentation unit 114 of this fact.

The method used to determine whether the simulated score corresponds to an outlier value is not particularly limited. For example, the determination method may be a determination method using Isolation Forest method, a determination method using LOF (Local Outlier Factor) method, or a determination method using OCSVM (One Class Support Vector Machine) method. The resemblance evaluation unit 113 may determine, for example, whether or not the simulated score corresponds to an outlier value using artificial intelligence.

Further, a method of determining whether or not the simulated score corresponds to an outlier value may be appropriately selected according to, for example, a feature amount to be determined, or may be appropriately selected by a user.

That is, the resemblance evaluation unit 113 may perform evaluation of the resemblance using any method as long as it can appropriately evaluate the resemblance between the actual measurement score and the simulated score.

The presentation unit 114 acquires, from the resemblance evaluation unit 113, an evaluation result of the resemblance between the plurality of measured scores and the simulated score. The presentation unit 114 presents a sample having an actual measurement score with the highest resemblance to the simulated score.

With such a configuration, the analysis system 1 according to the present embodiment can allow the user to easily confirm the measurement data similar to the simulated data.

More specifically, the presentation unit 114 according to the present embodiment presents a sample having an actual measurement score with the highest resemblance to the simulated score by displaying the corresponding measurement data. However, the configuration of the presentation unit 114 according to the present disclosure is not limited to this, and for example, identification information of a sample may be presented to a user.

That is, the presentation unit 114 according to the present disclosure may have any configuration as long as it can present a sample that is most similar to the simulated score.

Further, the presentation unit 114 according to the present embodiment acquires the simulated data from the simulated data output unit 115. Then, the presentation unit 114 according to the present embodiment displays the measurement data of the sample having the measurement score with the highest resemblance to the simulation score and the simulation data in parallel.

FIG. 5 is a schematic screen diagram for describing the configuration of the presentation unit 114 according to the first embodiment. More specifically, FIG. 5 is an example of a control screen displayed on the user terminal 200 by the presentation unit 114 in order to present a sample having an actual measurement score with the highest resemblance to the simulated score.

As illustrated in FIG. 5, the presentation unit 114 may display, on the user terminal 200, a control screen P2 in which the simulated data display area P21 for displaying the simulated data and the measured data display area P22 for displaying the measured data are displayed side by side. Further, as illustrated in FIG. 5, the presentation unit 114 may display the control screen P2 adjacently to the control screen P1 described above.

In other words, the server 100 displays the control screen P1 for receiving the simulated score from the user, the simulated data display area P21 for displaying the simulated data outputted based on the received simulated score, and the measured data display area P22 for displaying the measured data of the sample having the actual measurement score with the highest resemblance to the simulated score.

Note that the arrangement of the control screen P1, the simulated data display area P21, and the measured data display area P22 on the screen is not limited to the arrangement as illustrated in FIG. 5, and may be appropriately set in view of design and the like.

For example, the server 100 according to the present disclosure may be configured such that the control screen P1 and the simulated data display area P21 are arranged side by side in the horizontal direction, and the simulated data display area P21 and the measured data display area P22 are arranged side by side in the vertical direction.

In addition, the server 100 according to the present disclosure may be configured such that the control screen P1 and the simulated data display area P21 are arranged side by side and the measured data display area P22 is displayed in a separate window.

By arranging the control screen P1 and the simulated data display area P21 side by side, the analysis system 1 according to the present embodiment can allow the user to intuitively understand the effect of the feature amount on the measured data.

In addition, by arranging the simulated data display area P21 and the measured data display area P22 side by side, the analysis system 1 according to the present embodiment can allow the user to easily determine the validity of the simulated data.

Further, by arranging the control screen P1 and the measured data display area P22 side by side, the analysis system 1 according to the present embodiment can allow the user to easily grasp measured data having characteristics desired by the user.

Note that the presentation unit 114 according to the present embodiment may not present a sample when the resemblance evaluation unit 113 determines that the simulated score corresponds to the outlier value. In this case, the presentation unit 114 according to the present embodiment may notify the user that the simulation score corresponds to the outlier value.

According to such a configuration, the analysis system 1 according to the present embodiment can allow the user to easily determine the validity of the simulated data.

As described above, the analysis system according to the present embodiment evaluates the resemblance between the plurality of actual measurement scores and the simulated score, and presents a sample having the actual measurement score with the highest resemblance to the simulated score.

With such a configuration, the analysis system according to the present embodiment can allow the user to easily confirm the measurement data similar to the simulated data.

### Operation of the Analysis System

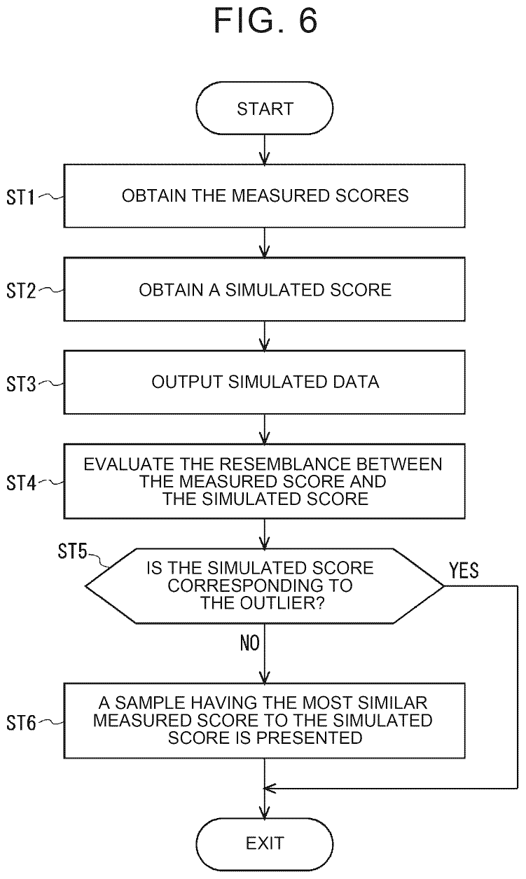

Next, the operation of the analysis system, that is, the analysis method according to the first embodiment will be described in detail. FIG. 6 is a flowchart illustrating an operation of the analysis system according to the first embodiment. In the following description, reference is made to FIGS. 1 to 5 as appropriate.

In the processing procedure of FIG. 6, the processor 110 included in the server 100 functions as an actual measurement score acquisition unit 111, a simulated score acquisition unit 112, a resemblance evaluation unit 113, a presentation unit 114, and a simulated data output unit 115 by reading and executing a program stored in the storage device 130 into the memory 120.

In the analysis methods according to the present embodiment, first, the processor 110 acquires an actual measurement score (ST1). More specifically, in ST1, the processor 110 according to the present embodiment acquires the characteristic values of the measurement data obtained by actually measuring the samples as actual measurement scores. In other words, in ST1, the processor 110 functions as the actual measurement score acquisition unit 111.

Note that ST1 may be a step in which the processor 110 acquires an actual measurement score by extracting a feature amount from a plurality of measurement data. In addition, ST1 may be a process in which the processor 110 acquires an actual measurement score from a database stored in the storage device 130 or the like.

ST1 may be a step performed after ST3.

In the analysis methods according to this embodiment, the processor 110 then ST2 the simulated scores. More specifically, in ST2, the processor 110 according to the present embodiment acquires the characteristic values of the simulated samples defined by the user as the simulated scores. That is, in ST2, the processor 110 functions as the simulated score acquisition unit 112.

In the analysis methods according to this embodiment, the processor 110 then ST3 the simulated data. More specifically, in ST3, the processor 110 according to the present embodiment simulates the measured data of the simulated samples based on the simulated scores, and outputs the simulated data. That is, in ST3, the processor 110 functions as the simulated data output unit 115.

Note that in ST3, the processor 110 may present the outputted simulated data to the user. That is, in ST3, the processor 110 may cause the user terminal 200 to display the simulated data.

In the analysis methods according to the present embodiment, the processor 110 then evaluates the resemblance between the measured score and the simulated score (ST4). That is, in ST4, the processor 110 functions as the resemblance evaluation unit 113.

In the analysis methods according to the present embodiment, the processor 110 then determines whether the simulated score corresponds to an outlier (ST5). More specifically, in ST5, the processor 110 according to the present embodiment determines whether or not the simulated score corresponds to an outlier in a data group including a plurality of acquired actual measurement scores. That is, in ST5, the processor 110 functions as the resemblance evaluation unit 113.

When the simulated score does not fall within the outlier (ST5NO), the processor 110 presents the sample having the most similar measured score to the simulated score (ST6), and the analysis system 1 terminates the sequence of operations. With such a configuration, the analysis system 1 according to the present embodiment can allow the user to easily confirm the measurement data similar to the simulated data.

When the simulated score corresponds to an outlier (ST5YES), the analysis system 1 terminates the sequence of operations. That is, when the simulated score corresponds to an outlier, the processor 110 does not present a sample having the measured score that is most similar to the simulated score.

According to such a configuration, the analysis system 1 according to the present embodiment can allow the user to easily determine the validity of the simulated data.

As described above, in the analysis method according to the present embodiment, the resemblance between the plurality of actual measurement scores and the simulated score is evaluated, and a sample having the actual measurement score with the highest resemblance to the simulated score is presented.

With such a configuration, the analysis method according to the present embodiment can allow the user to easily confirm measurement data similar to the simulated data.

Although the present disclosure has been described with reference to the above embodiments, it is to be understood that the disclosure is not limited only to the configuration of the above embodiments, but also includes various modifications, modifications, and combinations that may be made by a person skilled in the art within the scope of the claimed disclosure of the claims of the present application.

What is claimed is:

1. An analysis system comprising:
an actual measurement score acquisition unit that acquires a characteristic amount of measurement data obtained by actually measuring a sample as an actual measurement score;
a simulated score acquisition unit that acquires a characteristic amount of a simulated sample specified by a user as a simulated score;
a resemblance evaluation unit that evaluates resemblance between a plurality of actual measurement scores and the simulated score; and
a presentation unit that presents the sample having the actual measurement score with a highest resemblance to the simulated score.

2. The analysis system according to claim 1, further comprising a simulated data output unit that simulates measurement data of the simulated sample based on the simulated score and outputs the simulated measurement data as simulated data, wherein
the presentation unit displays the measurement data of the sample having the actual measurement score with the highest resemblance to the simulated score and the simulated data in parallel.

3. The analysis system according to claim 1, wherein the characteristic amount is a principal component score obtained as a result of performing a principal component analysis on a plurality of pieces of the measurement data.

4. The analysis system according to claim 1, wherein:
the resemblance evaluation unit determines whether the simulated score corresponds to an outlier value in a data group including a plurality of actual measurement scores acquired; and
the presentation unit does not present the sample when the resemblance evaluation unit determines that the simulated score corresponds to an outlier value.

5. An analysis method comprising:
acquiring a characteristic amount of measurement data obtained by actually measuring a sample as an actual measurement score;
acquiring a characteristic amount of a simulated sample specified by a user as a simulated score;
evaluating resemblance between a plurality of actual measurement scores and the simulated score; and
presenting the sample having the actual measurement score with a highest resemblance to the simulated score.
